(19) United States
(12) Patent Application Publication
(10) Pub. No.: US 2003/0161711 A1
(43) Pub. Date: Aug. 28, 2003

(54) Chip removal apparatus, chip removal system, fitting system and method of removing chips from a wafer

(76) Inventor: Yim Bun Patrick Kwan, Aalen (DE)

Correspondence Address: HARNESS, DICKEY & PIERCE, P.L.C., P.O.BOX 8910, RESTON, VA, 20195, US

(21) Appl. No.: 10/352,082

(22) Filed: Jan. 28, 2003

(30) Foreign Application Priority Data
Jan. 30, 2002 (DE) 10203601.2

(51) Int. Cl. B65G 49/07

(52) U.S. Cl. 414/759; 414/771; 414/774; 414/783; 414/941

(57) ABSTRACT

A chip removal apparatus, chip removal system, fitting system and method of removing chips from a wafer, involve a removal tool and a turning tool, designed to be rotatable. The removal tool is used for removing chips from a wafer. The chips removed can either be transferred in a turned state to a fitting head at a first transfer position, or can be transferred from the removal tool to the turning tool and rotated by the latter into a second transfer position, where then they can be removed in an unturned state by a fitting head of a fitting system. This allows continuous and flexible removal of chips from a wafer in large numbers.

The present application hereby claims priority under 35 U.S.C. §119 on German patent application number DE 10203601.2 filed Jan. 30, 2002, the entire contents of which are hereby incorporated herein by reference.

### FIELD OF THE INVENTION

The invention generally relates to a chip removal apparatus, a chip removal system, a fitting system and/or a method of removing chips from a wafer, preferably one in which the chips are removed directly from a semiconductor wafer.

### BACKGROUND OF THE INVENTION

With an increasing reduction in the housing size and the mounting costs, the fitting of semiconductor wafers directly to a substrate, either in a turned alignment as a flip-chip or in an unturned alignment on substrates is becoming more and more important. For this reason, the most recent developments of feed apparatuses for SMT applications have the possibility of processing COB (chip-on-board) and FCOB (flip-chip-on-board) components. The known designs of such feed apparatuses have a conventional pick-and-place mechanism, by which the chips can be removed from a semiconductor wafer. In addition, in the case of the known feed apparatuses, a turning station is provided, to which the removed chips have to be transferred in order to turn the same.

Proposals of this type are known, for example from U.S. Pat. Nos. 6,171,049 and 6,173,750. However, both proposals have the disadvantage that, firstly, picking up chips from the wafer and turning the chips picked up have to be carried out one after another. In addition, in the case of both proposals it is necessary to carry out a discontinuous movement in a first direction in order to pick up the appropriate chip and in an opposite, second direction in order to return the removal tool to its initial position. In the case of current fitting apparatuses and fitting systems which are designed for a high throughput, disadvantages of this type have an effect which reduces performance severely, however.

### SUMMARY OF THE INVENTION

It is therefore an object of an embodiment of the invention to specify a chip removal apparatus, a chip removal system, a fitting system and a method of removing chips from a wafer in which substantially continuous operation with high numbers of parts is possible.

According to an embodiment of the invention, a chip removal apparatus for removing chips from structured semiconductor wafers is provided which has a removal tool for removing the chips from the wafer and for turning the chips removed, and also a turning tool for the renewed turning of the chips removed, the removal tool having a first transfer position and the turning tool having a second transfer position, at which the chips can be transferred to a fitting head for further processing. With the chip removal apparatus according to an embodiment of the invention, it is possible, in a continuous operation, to pick up chips from a wafer and to transfer them, turned or unturned, at a transfer position for further processing, for example to a fitting head of a fitting system. In this way, continuous operation of the chip removal apparatus with high numbers of parts is possible.

For example, the removal tool and the turning tool can each have a plurality of grippers, by which the chips can be removed from the wafer and by which the chips are held while they are being turned.

The grippers of the removal tool and of the turning tool are in each case arranged rotationally symmetrically so that they can rotate about a common axis of rotation. By this, for example, at one point a gripper belonging to the removal tool can pick up a chip while, at the same time at a different gripper, a chip held there can be made ready for transfer.

The direction of rotation of the removal tool can be opposite to the direction of rotation of the turning tool. In this way, for example, a plurality of chips corresponding to the plurality of grippers of the turning tool can be stored temporarily on the turning tool.

It is possible to arrange the first transfer position and the second transfer position in one plane. By this, both turned chips and unturned chips can be made ready for transfer in a single plane, as a result of which rapid collection of turned and of unturned chips from the first and from the second transfer position, for example by means of a fitting head of a fitting system, is possible.

In order to permit interaction between the removal tool and the turning tool, for example, a common third transfer position can be provided between the removal tool and the turning tool. The third transfer position is in this case arranged in a region of the smallest distance between the removal tool and the turning tool. This makes it possible, by use of the removal tool, to transfer removed chips to the turning tool and in this way to turn them again.

As a result of continuous rotation both of the removal tool and of the turning tool, continuous operation with the chip removal apparatus according to an embodiment of the invention is possible. By this, a high throughput is possible, and it is also possible in a flexible manner to make both turned and unturned chips ready for transfer.

According to an embodiment of the invention, a chip removal system is also provided, which has a chip removal apparatus as described above and, furthermore, can be provided with an ejector, by which the chips to be removed from the wafer can be lifted. For example, the ejector is arranged opposite the removal tool with respect to the wafer. In this way, before the chip is removed by the grippers of the removal tool, the respective chip can be lifted, so that removal is made easier.

It is also possible additionally to provide an image processing system, by which image information about chips held on the grippers of the removal tool and/or of the turning tool can be determined. To this end, the image processing system is arranged at the side of the removal tool and/or at the side of the turning tool, so that it can register the held chips at least in a lateral view or in a plan view. This makes it possible, during continuous operation and without any loss in time, to check the correct seat of the removed chip on the corresponding grippers or to verify whether the correct chip type has been removed from the wafer.

The chip removal apparatus according to an embodiment of the invention can also be used in a fitting system as a fitting head. In this case, a pick-up position, at which the chips are picked up or removed from the wafer, and the first and the second transfer position and the chip removal apparatus are arranged in one plane. However, it is also possible to arrange the pick-up position and the two transfer positions in different planes. In this way, removal by use of the fitting head according to an embodiment of the invention of chips from a wafer is possible from different layers of the wafer, it being possible by use of the same fitting head for the removed chips to be fitted to a substrate which, for example, is aligned horizontally.

It is also possible to combine the pick-up position with the first transfer position. In this embodiment, the removed chips are also output to the substrate to be fitted at the same position of the removal tool at which they were removed from the wafer.

Like the chip removal system according to an embodiment of the invention, the fitting system can also be provided with an ejector. Furthermore, the fitting system can also have an image processing system, similar to the image processing system of the chip removal system according to an embodiment of the invention.

Furthermore, according to an embodiment of the invention, a method of removing chips from a wafer is provided, in which the chips are removed by use of a removal tool that can be rotated about an axis of rotation, the removed chips are transported to a first transfer position as a result of rotation of the removal tool, and at the transfer position the chips are transferred for further processing, for example to a handling apparatus. According to an embodiment of the invention, therefore, in a single movement sequence, that is to say as a result of rotation of the removal tool, both the transport of the removed chips from the pickup position to the transfer position and also the turning of the removed chips are ensured. This makes it possible, quickly and reliably, to provide removed and turned chips at the transfer position.

According to an embodiment of the invention, two different operating modes are possible. Firstly, with each removal of a chip from the wafer, another already removed chip can be transferred to the handling device. In this case, this is a completely continuous operating mode. This is, for example, advantageous in the case of a stationary fitting head of a fitting system which, by way of the method according to an embodiment of the invention, is to be fed with the removed chips. Because of the fixed-location arrangement of the fitting head, however, a movement of the wafer is necessary in order to remove the large number of chips arranged on the wafer.

Furthermore, a partially continuous operating mode is also possible, in which first of all a plurality of chips are removed successively from the wafer and held by a plurality of grippers belonging to the removal tool and/or an additionally provided turning tool and therefore stored temporarily. The plurality of temporarily stored chips are then transferred successively to the handling device. This assumes that the handling device can successively accommodate a plurality of chips to be fitted.

Depending on whether the removed chips are processed only by the removal tool or else additionally by the turning tool, they are turned once or twice, in each case through 180°, about their longitudinal or transverse axis. It is therefore possible, according to an embodiment of the invention, both to provide turned chips (flip-chip) for the FCOB process (flip-chip-on-board) and also to provide unturned chips for the COB process (chip-on-board).

In this case, single turning is carried out only by the removal tool and double turning, that is to say providing the removed chips in the position originally assumed by the chips on the wafer, is carried out by the removal tool and by the turning tool in co-operation between the two. For this purpose, it is necessary to transfer the chip to be turned twice from the removal tool to the turning tool at a common transfer position of the removal tool and of the turning tool.

In order to make the transfer and the removal and the provision at the transfer position easier by use of the grippers provided on the apparatuses according to an embodiment of the invention, the grippers can be arranged, for example, in the radial direction of the removal tool and of the turning tool such that they can be moved on the removal tool and on the turning tool. In particular, the grippers are vacuum pipettes.

The rotation of the removal tool and of the turning tool is carried out, for example, in indexed movement steps, that is to say in uniform angular steps. This indexed movement is, for example, in each case carried out in a single direction of rotation of the removal tool and in a single direction of rotation of the turning tool in such a way that at positions other than the pick-up positions and the transfer positions of the removal tool and of the turning tool, further processing steps, such as measuring the removed chips by use of an image processing system, can be carried out in parallel with the removal, transport and provision at the transfer position, as a result of which the processing time decreases considerably because of the parallelization of individual steps.

The grippers of the removal tool and of the turning tool can in each case be adjusted individually in their radial position independently of one another. For example, an embodiment of the invention can be used with a feed module for components such as is used in fitting apparatuses. It is possible to process both horizontally and vertically arranged wafers. Furthermore, the wafer can be arranged so as to be moved or stationary.

In the case of the FCOB process, in which the turning function is carried out automatically by the removal tool, the removed chip is offered in the turned state at the first transfer position for transfer, for example, to a fitting head of a fitting system. Therefore, in this case, the turning tool is substantially redundant or can simply be used as a store for removed chips during the FCOB process. The removed chips are transferred directly from the removal tool to the fitting head of a fitting apparatus. In the case of the COB process, the removed chips are transferred from the removal tool to the turning tool and turned again by the latter, so that they are brought into the unturned state again. They can then be removed in the unturned state from the turning tool at its second transfer position by use of the fitting head.

While turned chips can be measured with a component camera in a fitting system, for example on the fitting head, the single possibility for measuring unturned chips is located at a position in which they are still on the turning tool. Therefore, according to an embodiment of the invention, the measurement of unturned chips of the COB process is implemented by providing an additional image processing system on the turning tool.

The above-described continuous operating mode is advantageous in particular when the time which is required to remove a chip from the wafer is substantially the same time which is used to transfer the removed chip to a fitting head. In this case, a moved wafer and also a stationary fitting head may be required. The transfer of the removed chip to the fitting head can in this case be carried out in parallel with the removal, as a result of which continuous, highly parallel operation is possible.

A somewhat more flexible operating mode has already been described above as a partly continuous operation or else as a collecting and transfer mode. In this case, first of all the removal tool and/or the turning tool picks up the removed chip and holds a plurality of these chips, while the fitting head of the fitting system is still carrying out its fitting operations. After that, the two are moved toward each other with respect to common transfer position, for example the first transfer position of the removal tool or the second transfer position of the turning tool. By stepwise movement of the removal tool and/or of the turning tool, a transfer of the removed chips which is continuous for this time period, from the removal tool or from the turning tool to the fitting head, is possible. In this way, the transfer time for transferring the removed chips from the chip removal system according to an embodiment of the invention or the chip removal apparatus according to an embodiment of the invention to a fitting head is minimized. In this case, the number of grippers provided overall on the chip removal system according to an embodiment of the invention and the chip removal apparatus according to an embodiment of the invention, which grippers can pick up removed chips, can be greater than or equal to the number of grippers which are provided on the fitting head.

### BRIEF DESCRIPTION OF THE DRAWINGS

The invention will be explained in more detail with reference to the drawing, in which:

FIG. 1 shows a preferred embodiment of the chip removal system according to an embodiment of the invention.

### DETAILED DESCRIPTION OF THE PREFERRED EMBODIMENTS

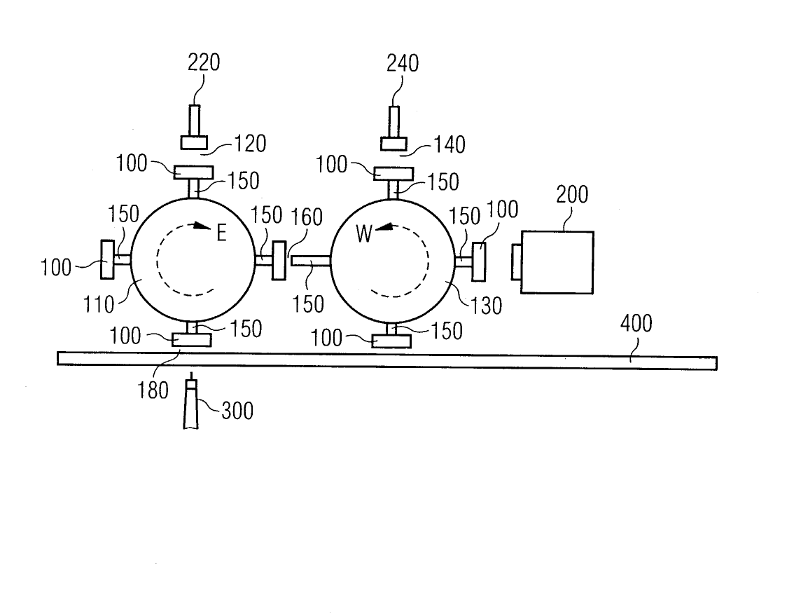

As can be seen from FIG. 1, a preferred embodiment of the invention has a removal tool 110, a turning tool 130 and a plurality of grippers 150, on which chips 100 which are removed from a wafer 400 can be held. The removal tool 110 has a first transfer position 120 and a pick-up position 180. At the pick-up position 180, chips 100 to be removed from the wafer 400 are picked up by the gripper located at the pick-up position 180 and belonging to the removal tool 110. This is possible, firstly, as a result of lowering the gripper 150, by the latter being moved radially in relation to the removal tool 110. Secondly, by use of an ejector 300 which is arranged opposite the pick-up position 180 with respect to the wafer 400 and opposite the removal tool 110, the chip 100 to be removed is moved toward the pick-up position 180, in the direction of the gripper 150, and is held on said gripper. A combination of the two aforementioned removal possibilities for chips 100 from the wafer 400 is also possible.

As can be seen from the figure, according to the preferred embodiment of the invention, for example four grippers 150 are provided on the removal tool 110 and four grippers 150 on the turning tool 130. The indexed movement of the removal tool 110 in the direction of rotation E, and also the indexed movement of the turning tool 130 in the direction of rotation W of the turning tool is therefore carried out in 90° steps in each case. In the case of a different number of grippers 150 on the removal tool 110 and on the turning tool 130 an appropriate, different angular stepwise movement of the removal tool 110 and of the turning tool 130 is provided. It is also possible to form the numbers of grippers 150 on the removal tool 110 to be different from those on the turning tool 130. As a result, different angular steps are also possible.

As a result of rotation of the removal tool 110, the removed chips 100, which are held by the grippers 150, pass to the first transfer position 120 of the removal tool 110. Here, they can be removed in a position turned through 180°, for example by a gripper 220 of a fitting head of a fitting system.

It is also possible to transport the removed chips 100 from the first transfer position 120 by one more angular step to a third, common transfer position 160 of the removal tool 110 and of the turning tool 130, where the removed chip 100 can be transferred from the gripper 150 of the removal tool 110 to a gripper 150 of the turning tool 130, which is likewise located at the third transfer position 160. As a result of the renewed transfer of the removed chip 100 and the rotation of the same in the direction of rotation W of the turning tool 130 into the second transfer position 140 of the turning tool 130, a removed chip 100 can be made ready in an unturned state for transfer to a gripper 240 of a fitting head of a fitting system, in the second transfer position 140.

It is, for example, also possible to provide an image processing system 200 at the side of the turning tool 130, by which the chips 100 held in an unturned state on the gripper 150 on the turning tool 130 are to be checked with regard to their position and their type.

Furthermore, an image processing system (not shown) can also be provided at the side of the removal tool 110 to check the position and the type of the chips 100 held on the grippers 150 of the removal tool 110 and located in a turned state.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A chip removal apparatus for removing chips from structured semiconductor wafers, comprising:
a rotatable removal tool for removing the chips from the wafer and for turning the removed chips; and
a rotatable turning tool for renewed turning of the removed chips if required, adapted to cooperate with the removal tool, wherein the removal tool includes a first transfer position and the turning tool includes a second transfer position, at which the chips are transferable for further processing.

2. The chip removal apparatus as claimed in claim 1, wherein the removal tool and the turning tool include a plurality of grippers for gripping the chips, arranged rotationally symmetrically so as to rotate about a common axis of rotation.

3. The chip removal apparatus as claimed in claim 2, wherein the direction of rotation of the removal tool is opposite to the direction of rotation of the turning tool.

4. The chip removal apparatus as claimed in claim 1, wherein the first transfer position and the second transfer position are arranged in one plane.

5. The chip removal apparatus as claimed in claim 2, wherein the grippers are vacuum pipettes.

6. The chip removal apparatus as claimed in claim 1, wherein a third common transfer position of the removal tool and of the turning tool are provided in a region of a relatively smallest distance between the removal tool and the turning tool, at the third position chips to be turned again are adapted to be transferred from the removal tool to the turning tool.

7. The chip removal apparatus as claimed in claim 1, wherein the removal tool and the turning tool are designed for continuous operation.

8. A chip removal system including a chip removal apparatus as claimed in claim 1, further comprising:
an ejector for lifting the chips to be removed from the wafer, arranged opposite the removal tool with respect to the wafer.

9. The chip removal system as claimed in claim 8, further comprising an image processing system, arranged at least one of at the side of the removal tool and at the side of the turning tool, by which image information about chips held on the grippers is determinable.

10. A fitting system for fitting components to substrates, comprising a chip removal apparatus as claimed in claim 1 as a fitting head.

11. The fitting system as claimed in claim 10, wherein a pick-up position at which the chips re adapted to be picked up by the removal tool, and the first and the second transfer position are arranged in one plane.

12. The fitting system as claimed in claim 11, wherein the pick-up position corresponds to the first transfer position.

13. The fitting system as claimed in claim 10, further comprising:
an ejector for lifting the chips to be removed from the wafer, the ejector being arranged opposite the pick-up position with respect to the wafer.

14. The fitting system as claimed in claim 10, further comprising:
an image processing system, arranged at least one of at the side of the removal tool and at the side of the turning tool, by which image information about chips held on the grippers is determinable.

15. A method of removing chips from a wafer, comprising:
removing the chips using a removal tool that is rotatable about an axis of rotation;
transporting the removed chips to a first transfer position as a result of rotation of the removal tool; and
transferring, at the first transfer position, the chips to a handling apparatus for further processing.

16. The method as claimed in claim 15, further comprising:
transferring, with each removal of a chip from the wafer, another already removed chip to the handling apparatus.

17. The method as claimed in claim 15, further comprising:
removing a first of all a plurality of chips successively from the wafer and holding it by a plurality of grippers belonging to the removal tool; and
transferring the plurality of held chips, successively, to the handling apparatus.

18. The method as claimed in claim 15, further comprising:
storing the removed chips temporarily, before the transfer, using a turning tool including a plurality of grippers.

19. The method as claimed in claim 18, further comprising:
turning the removed chips at least once, through 180° in each case, about at least one of their longitudinal and transverse axis.

20. The method as claimed in claim 18, further comprising:
carrying out the single turning by the removal tool; and
carrying out the double turning by the removal tool and by the turning tool, wherein a chip turned twice is transferred from the removal tool to the turning tool at a common transfer position of the removal tool and of the turning tool.

21. The chip removal apparatus of claim 1, wherein the chips are transferable for further processing to a fitting head.

22. The chip removal apparatus as claimed in claim 2, wherein the first transfer position and the second transfer position are arranged in one plane.

23. The chip removal apparatus as claimed in claim 3, wherein the grippers are vacuum pipettes.

24. The chip removal apparatus as claimed in claim 2, wherein a third common transfer position of the removal tool and of the turning tool are provided in a region of a relatively smallest distance between the removal tool and the turning tool, at the third position chips to be turned again are adapted to be transferred from the removal tool to the turning tool.

25. The chip removal apparatus as claimed in claim 2, wherein the removal tool and the turning tool are designed for continuous operation.

26. A chip removal system including a chip removal apparatus as claimed in claim 2, further comprising:
an ejector for lifting the chips to be removed from the wafer, arranged opposite the removal tool with respect to the wafer.

27. The chip removal system as claimed in claim 26, further comprising
an image processing system, arranged at least one of at the side of the removal tool and at the side of the turning tool, by which image information about chips held on the grippers is determinable.

28. A fitting system for fitting components to substrates, comprising a chip removal apparatus as claimed in claim 2 as a fitting head.

29. The fitting system as claimed in claim 28, wherein a pick-up position at which the chips re adapted to be picked up by the removal tool, and the first and the second transfer position are arranged in one plane.

30. The fitting system as claimed in claim 29, wherein the pick-up position corresponds to the first transfer position.

31. The fitting system as claimed in claim 11, further comprising:
an ejector for lifting the chips to be removed from the wafer, the ejector being arranged opposite the pick-up position with respect to the wafer.

32. The fitting system as claimed in claim 11, further comprising:
an image processing system, arranged at least one of at the side of the removal tool and at the side of the turning tool, by which image information about chips held on the grippers is determinable.

33. The fitting system as claimed in claim 12, further comprising:
an ejector for lifting the chips to be removed from the wafer, the ejector being arranged opposite the pick-up position with respect to the wafer.

34. The fitting system as claimed in claim 12, further comprising:
an image processing system, arranged at least one of at the side of the removal tool and at the side of the turning tool, by which image information about chips held on the grippers is determinable.

35. The method as claimed in claim 16, further comprising:
storing the removed chips temporarily, before the transfer, using a turning tool including a plurality of grippers.

36. The method as claimed in claim 17, further comprising:
storing the removed chips temporarily, before the transfer, using a turning tool including a plurality of grippers.

37. A device for removing chips from a wafer, comprising:
first means for removing the chips, wherein the first means is rotatable about an axis of rotation;
means for transporting the removed chips to a first transfer position as a result of rotation of the first means; and
means for transferring, at the first transfer position, the chips to a handling apparatus for further processing.

38. The device as claimed in claim 37, wherein, with each removal of a chip from the wafer, another already removed chip is transferred to the handling apparatus.

39. The device as claimed in claim 37, wherein the first means is for removing a first of all a plurality of chips successively from the wafer and holding it by a plurality of grippers;
and wherein the means for transferring transfers the plurality of held chips, successively, to the handling apparatus.

40. The device as claimed in claim 37, further comprising:
means for storing the removed chips temporarily, before the transfer, using a turning tool including a plurality of grippers.

41. The device as claimed in claim 40, further comprising:
means for turning the removed chips at least once, through 180° in each case, about at least one of their longitudinal and transverse axis.
